(19) United States
(12) Patent Application Publication
(10) Pub. No.: US 2008/0040691 A1
(43) Pub. Date: Feb. 14, 2008

(54) Device for controlling a software object and the method for the same

(75) Inventors: Chia-Hoang Lee, Chunan (TW); Ming-Chao Huang, Taipei (TW); Jian-Liang Lin, Tainan City (TW)

Correspondence Address: REED SMITH LLP, Suite 1400, 3110 Fairview Park Drive, Falls Church, VA, 22042, US

(73) Assignee: Chia-Hoang Lee

(21) Appl. No.: 11/889,494

(22) Filed: Aug. 14, 2007

(30) Foreign Application Priority Data
Aug. 14, 2006 (TW) 095129775

(51) Int. Cl. G06F 3/048

(52) U.S. Cl. 715/856

(57) ABSTRACT

The invention provides a device for controlling the movement of a software object in a display. The device includes a movable image-capturing module, a characteristic detecting module, a tracing and verifying module, and a guiding module. The movable image-capturing module captures a plurality of images and the characteristic detecting module determines a set of image characteristics according to the set of images. The tracing and verifying module generates a set of estimated movement parameters according to the set of image characteristics and a pre-stored reference characteristic. The guiding module generates a set of final movement parameters according to the set of estimated movement parameters and a pre-stored inertia parameter, wherein the guiding module updates the pre-stored inertia parameter according to the set of final movement parameters.

### BACKGROUND OF THE INVENTION

1. Field of the Invention

This invention relates to a controlling device of a software object for controlling the movement of the software object on a display and, more particularly, to control a software object (such as a cursor) in the display by moving a device that has an image capturing apparatus (such as a camera phone).

2. Description of the Prior Art

Please refer to FIG. 1. FIG. 1 is a schematic diagram illustrating a traditionally controlled software object 16 (such as a cursor) on a screen 10 by a mouse or a joystick. The mouse 14 may communicate with the computer in wired or wireless way. After mouse 14 moves from position A to position A′ on a real plane, the software object 16 relatively moves from position B to position B′. Although the way to control the movement of the software object 16 has been used for a long time, the mouse must moves on a real plane and generates a relative value of movement of the software object 16 by the measurement of track ball rolling or optical reflecting. But if a user moves the mouse in the air rather than on a real plane, the software object 16 will not move.

With the trends of a digital home, computer-related apparatuses in every household have become more diversified. It is inconvenient for the users when each apparatus corresponds to an individual controller, so it is a trend to provide an integrated controlling center which can control all apparatuses in a digital home. A mobile phone is almost a necessary device now that everyone carries. If a mobile phone can be made an integrated controlling center of a digital home, it will be a good news to users.

Accordingly, the controlling device of a software object of the invention can precisely control any software object in the screen and make wired communication or wireless communication with any computer to replace the common functions of a mouse or a joystick. Also, the controlling device of the invention does not have to move on a real plane (such as a table) but it can control the movement of any software object on the screen by moving in a three-dimensional space. The invention can replace a joystick or a controller through a camera phone, and through the uses of the camera phone, it can control the movement and velocity of an object (such as a racing car object in a car-racing program) in any display.

### SUMMARY OF THE INVENTION

A scope of the invention is to provide a controlling device of a software object for controlling the movement of a software object in a display. The controlling device does not have to move on a real plane, it can control the movement of a software object.

A scope of the invention is to provide a controlling device. The controlling device communicates with a display in wired or wireless way to control the movement of a software object in the display.

Another scope of the invention is to use the movement of a camera phone to control the movement of an object (such as a cursor) in the display.

Another scope of the invention is to replace a joystick or a controller with a camera phone and control the movement of an object (such as a racing car object in a car-racing program) in any display through the camera phone.

Another scope of the invention is to move a camera phone in a three-dimensional space rather than on a real plane to control the movement of an object in any display.

According to a preferred embodiment of the invention, the controlling device includes a movable image-capturing module, a characteristic detecting module, a tracing and verifying module, and a guiding module. The movable image-capturing module captures a plurality of images and the characteristic detecting module determines a set of image characteristics according to the set of images. The tracing and verifying module generates a set of estimated movement parameters according to the set of image characteristics and a pre-stored reference characteristic. The guiding module generates a set of final movement parameters according to the set of estimated movement parameters and a pre-stored inertia parameter, wherein the guiding module updates the pre-stored inertia parameter according to the set of final movement parameters.

Accordingly, the controlling device of a software object of the invention can precisely control any software object on the screen and make wired communication or wireless communication with any computer to replace the common functions of a mouse or a joystick. And, the controlling device of the invention does not have to move on a real plane (such as a table) but can control the movement of any software object on the screen by moving in a three-dimensional space.

Another scope of the invention is to provide a method for controlling movement of a software object. The method includes the steps of: (a) capturing a plurality of images; (b) generating a set of image characteristics according to the plurality of images; (c) generating a set of estimated movement parameters according to the set of image characteristics and a pre-stored reference characteristic; (d) generating a set of final movement parameters of the software object according to the set of the estimated movement parameters and a pre-stored inertia parameter; and (e) updating the pre-stored inertia parameter according to the set of final movement parameters. Accordingly, the movement parameters, which include the movement, velocity, or direction of any software object on the screen, can be precisely controlled.

The advantage and spirit of the invention may be understood by the following recitations together with the appended drawings.

### BRIEF DESCRIPTION OF THE APPENDED DRAWINGS

FIG. 1 is a schematic diagram illustrating the traditional control of a cursor in a display by a wired or a wireless mouse.

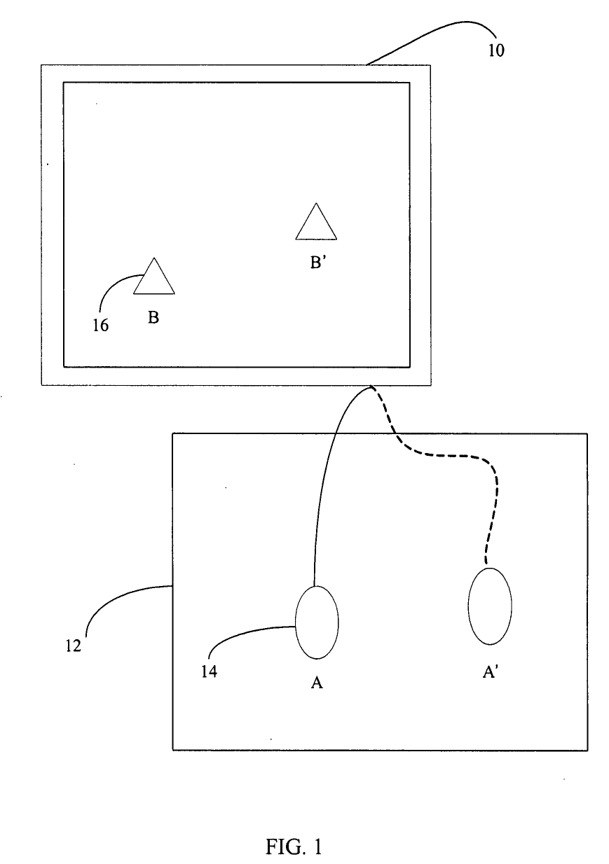

FIG. 2A is a schematic diagram illustrating the control of a cursor in a display by the controlling device of the invention.

FIG. 2B is a schematic diagram illustrating the circuit structure of the controlling device of the invention.

FIG. 3 is a flow chart of a controlling method of moving a software object of the invention.

FIG. 4 is a flow chart of setting a characteristic point inactive flag or a noise interference flag of the invention.

FIG. 5 is a flow chart of generating a final horizontal movement value and a final vertical movement value of the invention.

FIG. 6 is a flow chart of generating a final movement direction and updating a direction tolerant range value of the invention.

### DETAILED DESCRIPTION OF THE INVENTION

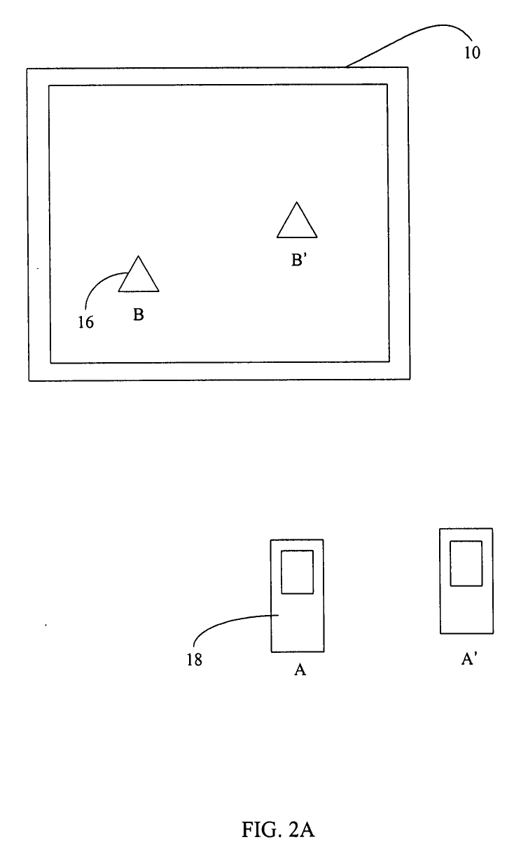

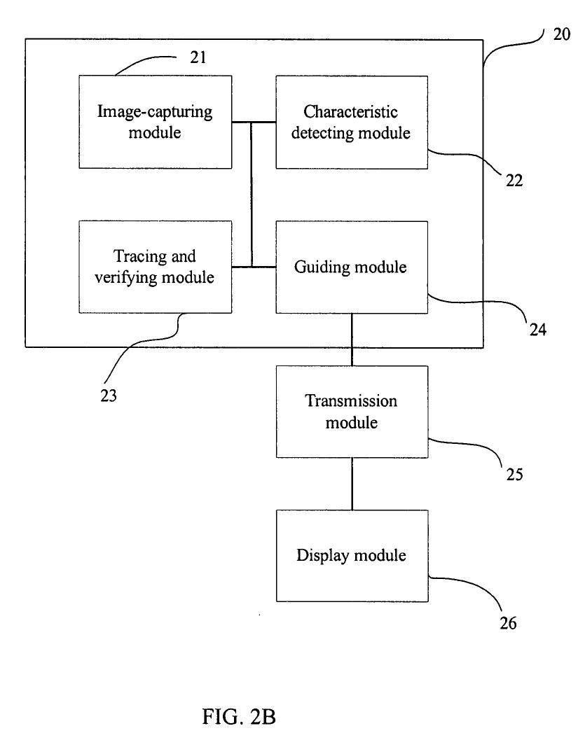

Referring to FIG. 2A. FIG. 2A is a schematic diagram illustrating the operation of the controlling device of the invention. The difference between the invention and prior art is that the controlling device of the invention does not have to move on a real plane but it can control the movement of a software object. For example, by moving the controlling device 18 of the invention form position A to position A′ in the air, the software object 16, which was originally at position B on the screen 10, will move from position B to position B′. The controlling device does not have to move on a real table but can move a software object in three-dimension space as well.

FIG. 2B is a schematic diagram illustrating the circuit structure of the controlling device of the invention. The controlling device 20 includes a movable image-capturing module 21, a characteristic detecting module 22, a tracing and verifying module 23, and a guiding module 24. The movable image-capturing module 21 captures a plurality of images by moving; the characteristic detecting module 22 generates a set of image characteristics according to the plurality of images; the tracing and verifying module 23 generates a set of estimated movement parameters of the software object according to the set of image characteristics and a pre-stored reference characteristic; the guiding module 24 generates a set of final movement parameters of the software object according to the set of estimated movement parameters and a pre-stored inertia parameter and updates the pre-stored inertia parameter according to the set of final movement parameters.

Wherein, the image-capturing module 21 can be a CCD image capturing device or a CMOS image capturing device. Now common mobile phones are all equipped with camera module, so mobile phones are well suited for the invention. The image-capturing module 21 can continuously capture streaming images of ambient environment by moving. The characteristic detecting module 22 can preprocess the streaming images to generate image characteristics. For example, the characteristic detecting module 22 can determine one or several image characteristics from the streaming images by using an edge detection algorithm. In order to increase the precision, the streaming images can still be separated into one or several horizontal characteristic points or vertical characteristic points according to horizontal direction or vertical direction.

The tracing and verifying module 23 generates a set of estimated movement parameters of the software object according to the set of image characteristics and a pre-stored reference characteristic. In order to increase the precision, the pre-stored reference characteristics are periodically updated by the characteristic detecting module, an example is that the characteristic detecting module 22 can periodically find and store one or several horizontal reference characteristic points or vertical reference characteristic points. The tracing and verifying module 23 can trace the positions of the characteristic points, verify the validity of the characteristic points, and analyze as well as compare the properties of characteristic points and ambient environment, such as the noise of the streaming images, to derive the initial relative motions between the image-capturing module 21 and ambient environment.

The set of the estimated movement parameters can include an estimated moving direction value, an estimated horizontal movement value, an estimated vertical movement value, and a set of control flags. For example, if a reference point of the original pre-stored reference characteristic is moving from a first position to a second position, the estimated value of movement and the direction between the first position and the second position can be generated to derive the initial relative motions between the image-capturing module 21 and ambient environment through comparison. The control flag can either be a characteristic point inactive flag or a noise interference flag of the invention. For example, the tracing and verifying module 23 can analyze and verify whether characteristic points exist in an intended searching range. If the characteristic points does not exist in the searching range, the tracing and verifying module 23 will detect characteristic points again, set up a new searching range and a characteristic point inactive flag. The tracing and verifying module 23 can still determine whether the characteristic points are interfered by noise. If interfered by noise, the tracing and verifying module 23 will set a noise interference flag.

The guiding module 24 generates a set of final movement parameters of the software object according to the set of estimated movement parameters and a pre-stored inertia parameter. The guiding module 24 is to receive the estimated movement parameters (such as to estimate movement, velocity, motion direction, a characteristic point inactive flag, and a noise interference flag) and to transform into a final movement according to the pre-stored inertia parameter (including habitual behaviors and cursor motion inertia of users) to make the final movement human-centered, such as high sensitivity and easiness of the movement of the software object, and finally derive the velocity and the direction of the movement of the software object.

For example, the pre-stored inertia parameter includes a previous horizontal movement value and a previous vertical movement value, and the guiding module 24 generates a final horizontal movement value and a vertical movement value of the set of final movement parameters according to the estimated horizontal movement value, the estimated vertical value, control flag content, the previous horizontal movement value, and the previous vertical movement value. For example, if the characteristic points are not inactive or if the noise can be tolerated and the noise interference flag needs not to be set, the guiding module 24 determines whether the present velocity or the movement falls under intended standards. If the velocity or the movement falls under the intended standards, they can be used to control the software object. If the velocity or the movement does not fall under the intended standards, they will be amended to control the software object.

In an embodiment, the intended standards are: (a) if the characteristic point inactive flag is set, the final horizontal movement value is set with the previous horizontal movement value and the final vertical movement value with the previous vertical movement value; (b) if the characteristic point inactive flag is not set and both the estimated horizontal movement value and the estimated vertical movement value are between the maximum value (representing the maximum velocity of the software object in a track) and the minimum value (representing the minimum friction of the software object in a track), the final horizontal movement value is set with the estimated horizontal movement value and the final vertical movement value with the estimated vertical movement value; (c) if the characteristic point inactive flag is not set and the estimated horizontal (or vertical) movement value is larger than the maximum value, the final horizontal (or vertical) movement value is set with the previous horizontal movement value; (d) if the characteristic point inactive flag is not set and the estimated horizontal (or vertical) movement value is smaller than the minimum value, the final horizontal (or vertical) movement value is set as 0.

Besides, the pre-stored inertia parameter includes a direction tolerant range value, and the guiding module 24 generates a final moving direction value of the set of final movement parameters according to the estimated moving direction value and the direction tolerant range value. For example, if the estimated moving direction value is within the direction tolerant range value, the estimated moving direction can be the final moving direction value; on the contrary, if the estimated moving direction value exceeds the direction tolerant range value, the limit value of the direction tolerant range value can be the final moving direction value.

In order to update using inertias of operators at any moment, the guiding module 24 respectively replaces the previous horizontal movement value and the previous vertical movement value by the final horizontal movement value and the final vertical movement value after generating the final horizontal movement value and the final vertical movement value. In other words, the previous horizontal movement value and the previous vertical movement value are updated every time after the moving and are replaced by the present final horizontal movement value and the final vertical movement value. At the same time, the guiding module 24 can also enlarge or diminish the direction tolerant range value according to the final horizontal movement value, the final vertical movement value, the previous horizontal movement value, and the previous vertical movement value. The guiding module 24 uses the final moving velocity or the movement to determine the allowed range of moving direction. The range is smaller while the velocity or the movement is larger, and the range is larger while the velocity or the movement is smaller.

So, the guiding module 24 can receive external information which includes information of image processing virtual object and cooperate with internal information which includes habitual behaviors, motion inertias of virtual object, stability of resisting noise interference, and smart track prediction, which allow a user and a computer to cooperate and smoothly control the virtual objects in the screen.

The controlling device of the software object in FIG. 2B can further include a transmission module 25 and a display module 26. The transmission module 25 is for transmitting the set of final movement parameters, and the display module 26 receives the set of final movement parameters and moving the software object on a screen according to the set of final movement parameters. Wherein, the transmission module is a wireless transmission device or a wired transmission device to transmit the set of final movement parameters in a wired or a wireless way. The wireless transmission device can use transmitting technologies such as infrared rays, Bluetooth, and WiFi, and the wired transmission device can use transmitting technologies such as USB and RS232. The common mobile phones which are equipped with camera functions are almost all equipped with functions of infrared rays transmission, Bluetooth, WiFi, or USB. So, camera phones of the invention can move the software object 16, which was originally at position B in the screen 20, and was moved from position B to position B′ by moving the controlling device 18 form position A to position A′ in the air. Of course, screen 20 can be the screen of camera phone or the screen of external computer or television.

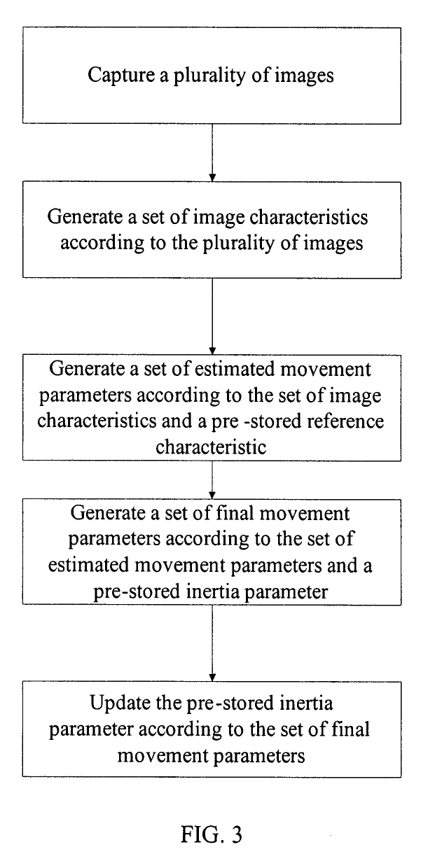

Referring to FIG. 3. FIG. 3 is a controlling method for moving a software object according to the invention. The controlling method includes the steps of:
(a) capturing a plurality of images;
(b) generating a set of image characteristics according to the plurality of images;
(c) generating a set of estimated movement parameters according to the set of image characteristics and a pre-stored reference characteristic;
(d) generating a set of final movement parameters of the software object according to the set of the estimated movement parameters and a pre-stored inertia parameter; and
(e) updating the pre-stored inertia parameter according to the set of final movement parameters.

The step (b) can continuously capture a plurality of images of ambient environment by moving the image capturing device. The step (b) can use an edge detection algorithm to determine one or several image characteristics from the captured plurality of images; the image characteristics can still be separated into one or several horizontal characteristic points or vertical characteristic points according to horizontal direction or vertical direction. In order to increase the precision, the step (c) further comprises the step of periodically updating the pre-stored reference characteristic.

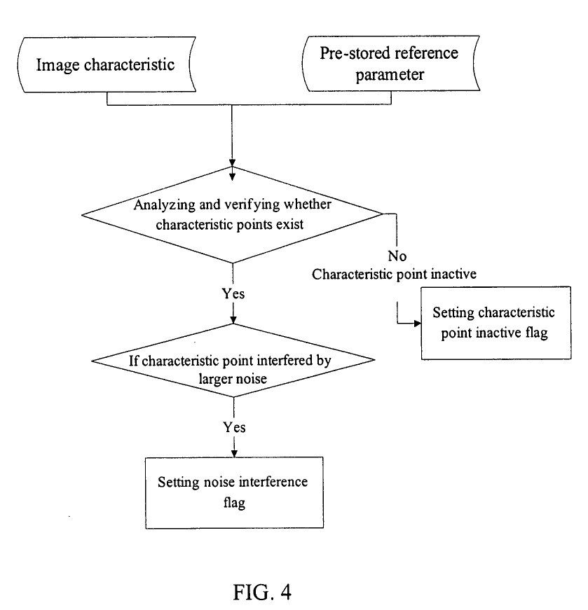

The set of estimated movement parameters of the step (c) includes an estimated moving direction value, an estimated horizontal movement value, an estimated vertical movement value, and a control flag, and the control flag can be a characteristic point inactive flag or a noise interference flag. Referring to FIG. 4. FIG. 4 is a flow chart of setting a characteristic point inactive flag or a noise interference flag of the invention, the invention analyzes and verifies whether characteristic points exist in an intended searching range by comparing the pre-stored reference characteristic and the set of image characteristics. If the characteristic points are not in the searching range, the invention detects characteristic points again, set a new searching range and set a characteristic point inactive flag.

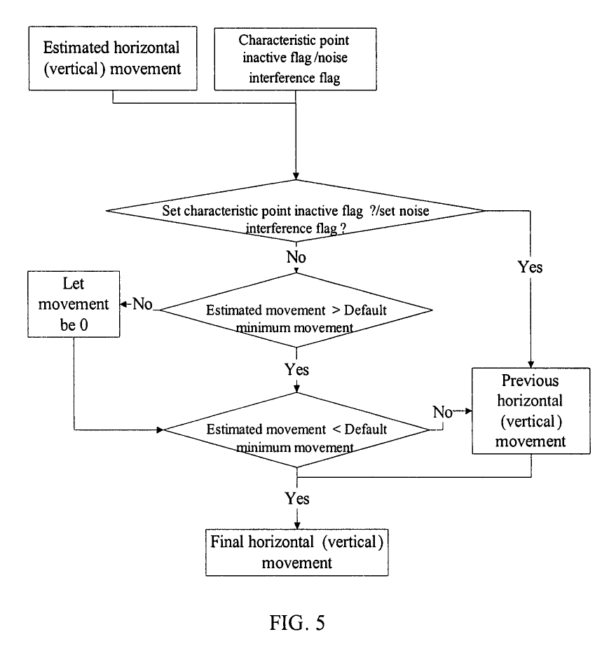

The step (d) generates a final horizontal movement value and a final vertical movement value of the set of the final movement parameters according to the estimated horizontal movement value, the estimated vertical movement value, the control flag, and the pre-stored inertia parameter. Referring to FIG. 5. FIG. 5 is a flow chart for generating a final horizontal movement value and a final vertical movement value of the invention, the step (d) determines whether the present velocity or movement are meeting the intended standards. If the velocity or the movement meets the intended standards, they can be used to control the software object. If the velocity or the movement cannot meet the intended standards, they will be amended to control the software object. For example, the pre-stored inertia parameter includes a previous horizontal movement value and a previous vertical movement value, and if the characteristic point inactive flag is set, the final horizontal movement value is set with the previous horizontal movement value and final vertical movement value with the previous vertical movement value. If the characteristic point inactive flag is not set and both the estimated horizontal movement value and the estimated vertical movement value are between the maximum value (representing the maximum velocity of the software object in a track) and the minimum value (representing the minimum friction of the software object in a track), the final horizontal movement value is set with the estimated horizontal movement value and the final vertical movement value with the estimated vertical movement value. If the characteristic point inactive flag is not set and the estimated horizontal (or vertical) movement value is larger than the maximum value, the final horizontal (or vertical) movement value is set with the previous horizontal movement value. If the characteristic point inactive flag is not set and the estimated horizontal (or vertical) movement value is smaller than the minimum value, the final horizontal (or vertical) movement value is set as 0. In other words, if the characteristic point is inactive, the invention generalizes the final moving velocity by using past moving information. Wherein, the step (e) respectively replaces the previous horizontal movement value and the previous vertical movement value by the final horizontal movement value and the final vertical movement value after generating the final horizontal movement value and the final vertical movement value.

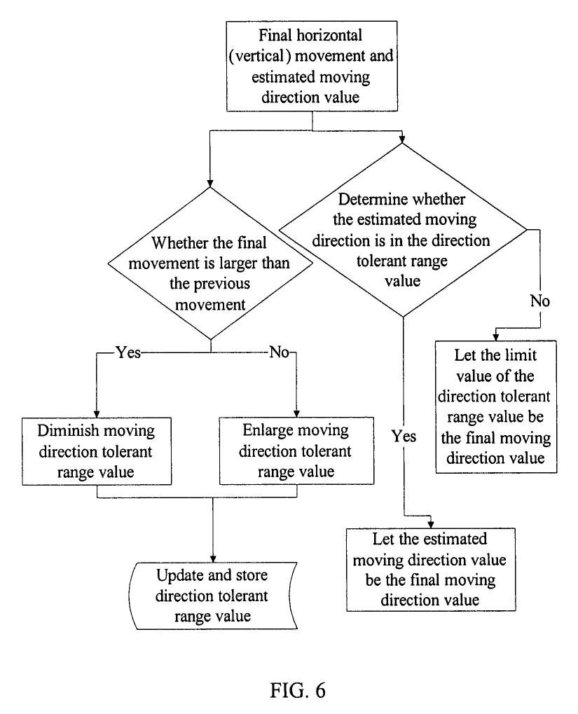

Besides, the pre-stored inertia parameter includes a direction tolerant range value, and the step (d) generates a final moving direction value of the set of final movement parameters according to the estimated moving direction value and the direction tolerant range value. Referring to FIG. 6. FIG. 6 is a flow chart for generating a final movement direction and updating a direction tolerant range value of the invention, if the estimated moving direction value is in the direction tolerant range value, the estimated moving direction can be the final moving direction value; on the contrary, if the estimated moving direction value exceeds the direction tolerant range value, the limit value of the direction tolerant range value can be the final moving direction value. The step (e) updates the direction tolerant range value according to the final horizontal movement value, the final vertical movement value, the previous horizontal movement value, and the previous vertical movement value. The step (e) uses the final moving velocity or the movement to determine the allowed range of moving direction. The range is smaller when the velocity or the movement is larger, and the range is larger when the velocity or the movement is smaller.

After generating the set of final movement parameters (including the final horizontal movement value, the final vertical movement value, and the final moving direction value), the controlling method of the invention further includes the steps of:
(f) transmitting the set of final movement parameters; and
(g) moving the software object on a screen according to the set of final movement parameters.

Accordingly, the invention can control the movement of a software object in a display. Wherein, the step (f) transmits the set of final movement parameters in a wired or wireless way. The wireless transmission can use transmitting technologies such as infrared rays, Bluetooth, and Wireless Access Protocol such as IEEE802.11, and wired transmission can use transmitting technologies such as USB and RS232. After receiving the final movement parameter, the invention can control the moving of the software object 16, which was originally at position B on the screen 20, moving from position B to position B′.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A controlling device for controlling the movement of a software object, comprising:
a movable image-capturing module capturing a plurality of images by moving;
a characteristic detecting module generating a set of image characteristics according to the plurality of images;
a tracing and verifying module generating a set of estimated movement parameters of the software object according to the set of image characteristics and a pre-stored reference characteristic; and
a guiding module generating a set of final movement parameters of the software object according to the set of estimated movement parameters and a pre-stored inertia parameter;
wherein the pre-stored inertia parameter is updated by the guiding module according to the set of final movement parameters.

2. The controlling device of claim 1, wherein the pre-stored reference characteristic are periodically updated by the characteristic detecting module.

3. The controlling device of claim 1, wherein the characteristic detecting module generates a horizontal characteristic and a vertical characteristic of the set of image characteristics according to an edge detection algorithm.

4. The controlling device of claim 3, the set of the estimated movement parameters comprising an estimated moving direction value, an estimated horizontal movement value, an estimated vertical movement value, and a set of control flags, and the guiding module generating a final horizontal movement value and a final vertical movement value of the set of the final movement parameters according to the estimated horizontal movement value, the estimated vertical movement value, the set of control flags, and the pre-stored inertia parameter.

5. The controlling device of claim 4, the pre-stored inertia parameter comprising a previous horizontal movement value and a previous vertical movement value, and the guiding module respectively updating the previous horizontal movement value and the previous vertical movement value by the final horizontal movement value and the final vertical movement value after generating the final horizontal movement value and the final vertical movement value.

6. The controlling device of claim 4, the pre-stored inertia parameter comprising a direction tolerant range value and the guiding module generating a final moving direction value of the set of final movement parameters according to the estimated moving direction value and the direction tolerant range value.

7. The controlling device of claim 6, the guiding module updating the direction tolerant value according to the final horizontal movement value, the final vertical movement value, the previous horizontal movement value and the previous vertical movement value.

8. The controlling device of claim 1, further comprising:
a transmission module for transmitting the set of final movement parameters; and
a display module receiving the set of final movement parameters and moving the software object on a screen according to the set of final movement parameters.

9. The controlling device of claim 8, wherein the transmission module is a wireless transmission device or a wired transmission device.

10. The controlling device of claim 1, wherein the image-capturing module is a CCD image capturing device or a CMOS image capturing device.

11. A method for controlling movement of a software object, comprising the steps of:
(a) capturing a plurality of images;
(b) generating a set of image characteristics according to the plurality of images;
(c) generating a set of estimated movement parameters according to the set of image characteristics and a pre-stored reference characteristic;
(d) generating a set of final movement parameters of the software object according to the set of the estimated movement parameters and a pre-stored inertia parameter; and
(e) updating the pre-stored inertia parameter according to the set of final movement parameters.

12. The method of claim 11, wherein the step (c) further comprises the step of: periodically updating the pre-stored reference characteristic.

13. The method of claim 12, wherein the step (d) generates a horizontal characteristic and a vertical characteristic of the set of image characteristics according to an edge detection algorithm.

14. The method of claim 13, the set of estimated movement parameters comprising an estimated moving direction value, an estimated horizontal movement value, an estimated vertical movement value, and a control flag, wherein the step (d) generates a final horizontal movement value and a final vertical movement value of the set of the final movement parameters according to the estimated horizontal movement value, the estimated vertical movement value, the control flag, and the pre-stored inertia parameter.

15. The method of claim 14, wherein the control flag is generated after comparing the pre-stored reference characteristic and the set of image characteristics.

16. The method of claim 14, the pre-stored reference parameter comprising a previous horizontal movement value, a previous vertical movement value, a maximum value, and a minimum value, the method further comprising the steps of:
(d1) if the control flag is set, setting the final horizontal movement value with the previous horizontal movement value and final vertical movement value with the previous vertical movement value;
(d2) if the control flag is not set and both the estimated horizontal movement value and the estimated vertical movement value are between the maximum value and the minimum value, setting the final horizontal movement value with the estimated horizontal movement value and the final vertical movement value with the estimated vertical movement value;
(d3) if the control flag is not set and the estimated horizontal movement value is larger than the maximum value, setting the final horizontal movement value with the previous horizontal movement value;
(d4) if the control flag is not set and the estimated vertical movement value is larger than the maximum value, setting the final vertical movement value with the previous vertical movement value;
(d5) if the control flag is not set and the estimated horizontal movement value is smaller than the minimum value, setting the final horizontal movement value as 0; and
(d6) if the control flag is not set and the estimated vertical movement value is smaller than the minimum value, setting the final vertical movement value as 0.

17. The method of claim 16, wherein the step (e) respectively updates the final the previous horizontal movement value and the previous vertical movement value by the final horizontal movement value and the final vertical movement value after generating the final horizontal movement value and the final vertical movement value.

18. The method of claim 14, the pre-stored inertia parameter comprising a direction tolerant range value, wherein the step (d) generates a final moving direction value of the set of final movement parameters according to the estimated moving direction value and the direction tolerant range value.

19. The method of claim 18, wherein the step (e) updates the direction tolerant value according to the final horizontal movement value, the final vertical movement value, the previous horizontal movement value and a previous vertical movement value.

20. The method of claim 11, further comprising the steps of:
(f) transmitting the set of final movement parameters; and
(g) moving the software object on a screen according to the set of final movement parameters.
